(19) United States
(12) Patent Application Publication
(10) Pub. No.: US 2008/0283594 A1
(43) Pub. Date: Nov. 20, 2008

(54) Systems and methods for implementing debit card account restrictions

(76) Inventor: John Baron Unbehagen, Austin, TX (US)

Correspondence Address: SMITH FROHWEIN TEMPEL GREENLEE BLAHA, LLC, Two Ravinia Drive, Suite 700, ATLANTA, GA, 30346, US

(21) Appl. No.: 11/803,579

(22) Filed: May 14, 2007

(51) Int. Cl. G06K 5/00; G06Q 40/00

(52) U.S. Cl. 235/380; 705/35

(57) ABSTRACT

A method includes receiving from a remotely located computer information identifying at least one purchase category, wherein the information is transmitted by the computer responsive to user input provided to the computer by a bank customer having a debit card account with a bank; after receiving the information identifying the at least one purchase category, receiving an authorization request for a transaction corresponding to the debit card account; and causing the authorization request to be declined responsive to the at least one purchase category.

### BACKGROUND

A debit card is typically a plastic card which provides an alternative payment method to cash when making purchases. Using a debit card to make a purchase results in funds being withdrawn directly from the cardholder's bank account. When making a purchase, the customer's debit card is swiped through a card reader or inserted into a chip reader and the merchant usually enters the amount of the transaction before the customer enters their PIN (personal identification number). There is usually a short delay while the EFTPOS (Electronic Funds Transfer at Point of Sale) terminal contacts an authorization server to verify and authorize the transaction.

In some countries a debit card is multipurpose, acting as an automated teller machine (ATM) card for withdrawing cash from an ATM and as a check guarantee card. Merchants can also offer a cash-back or cash-out feature to customers, where a customer can withdraw cash along with their purchase. Debit cards are also used widely for telephone and Internet purchases.

Some debit card account owners desire to prevent either themselves or other users of the debit card from purchasing certain types of products or services via the debit card. For example, a parent that provides his child with a credit card may desire to prevent his child from using the debit card to purchase alcoholic beverages.

### SUMMARY

Systems and methods for implementing debit card account restrictions are disclosed. An embodiment of such a method includes: receiving from a remotely located computer information identifying at least one purchase category, wherein the information is transmitted by the computer responsive to user input provided to the computer by a bank customer having a debit card account with a bank; after receiving the information identifying the at least one purchase category, receiving an authorization request for a transaction corresponding to the debit card account; and causing the authorization request to be declined responsive to the at least one purchase category.

Another embodiment of a method for implementing debit card account restrictions includes: receiving from a remotely located computer information identifying at least one merchant category, wherein the information is transmitted by the computer responsive to user input provided to the computer by a bank customer having a debit card account with a bank; after receiving the information identifying the at least one merchant category, receiving an authorization request for a transaction corresponding to the debit card account; and causing the authorization request to be declined responsive to the at least one merchant category.

An embodiment of a system for implementing debit card account restrictions includes: a first server configured to receive from a remotely located computer information identifying at least one purchase category, wherein the information is transmitted by the computer responsive to user input provided to the computer by a bank customer having a debit card account with a bank; and a second server configured to: receive an authorization request for a transaction corresponding to the debit card account; and cause the authorization request to be declined responsive to the at least one purchase category.

Other systems, methods, features, and advantages of the present systems and methods will be or become apparent to one with skill in the art upon examination of the following drawings and detailed description. It is intended that all such additional systems, methods, features, and advantages be included within this description and be within the scope of the attached claims.

### BRIEF DESCRIPTION OF THE DRAWINGS

The present systems and methods can be better understood with reference to the following figures. The components within the figures are not necessarily to scale, emphasis instead being placed upon clearly illustrating principles associated with implementing debit card account restrictions. Moreover, in the figures, like reference numerals designate corresponding parts throughout the different views.

FIGS. 1A-1C are block diagrams depicting respective embodiments of transaction systems.

FIG. 2 is a flowchart depicting an embodiment of a method for setting merchant code restrictions for a debit card account.

FIGS. 3A-3B are diagrams depicting respective embodiments of graphical user interfaces used to select authorized merchant codes.

FIG. 4 is a flowchart depicting an embodiment of a method for processing an authorization request with merchant code limitations.

FIG. 5 is a block diagram illustrating an embodiment of a customer computer.

FIG. 6 is a block diagram illustrating an embodiment of a bank server.

FIG. 7 is a block diagram illustrating an embodiment of another bank server.

### DETAILED DESCRIPTION

According to one embodiment, a customer is able to set a merchant code restriction for his or her debit card account. A debit card is a card that functions like a check and through which payments for purchases or services are made electronically to the bank accounts of participating retailing establishments directly from respective debit card accounts of the debit card holders. In some cases, such as in internet transactions, purchases can be made via a debit card account by using a debit card number, without the need for the actual debit card. Therefore, embodiments described herein can apply to debit card transactions that are attempted with or without physical debit cards, and even to debit card accounts for which no physical debit cards are issued.

Merchant codes are used to identify types of merchants. As a non-limiting example, merchant codes can identify a merchant as falling into one of the following categories: restaurants, hotels, airlines, supermarkets, drug stores, gasoline stations, financial institutions, motion picture theaters, and/or dry cleaners, among others. The foregoing merchant categories are just examples. Different and/or additional merchant classifications could also be used.

When an authorization request is transmitted to an authorization server, a merchant code is transmitted along with the purchase amount. Payment methods can prevent certain merchant codes from being authorized or alternatively allow only certain merchant codes. For example, a trucker may be given a debit card by his or her employer. The debit card may only be intended for use for gas/fuel purchases. Thus, the employer may wish to set a restriction on the card so that only fuel purchases are authorized, and all non-fuel purchases are declined. Thus, any purchase attempt using the card will transmit an authorization request to an authorization server along with the merchant code for the items subject to the purchase. If the merchant code corresponds to fuel, then, in this example, authorization will be approved. If the merchant code corresponds to a good/service other than fuel, then the authorization request will be declined.

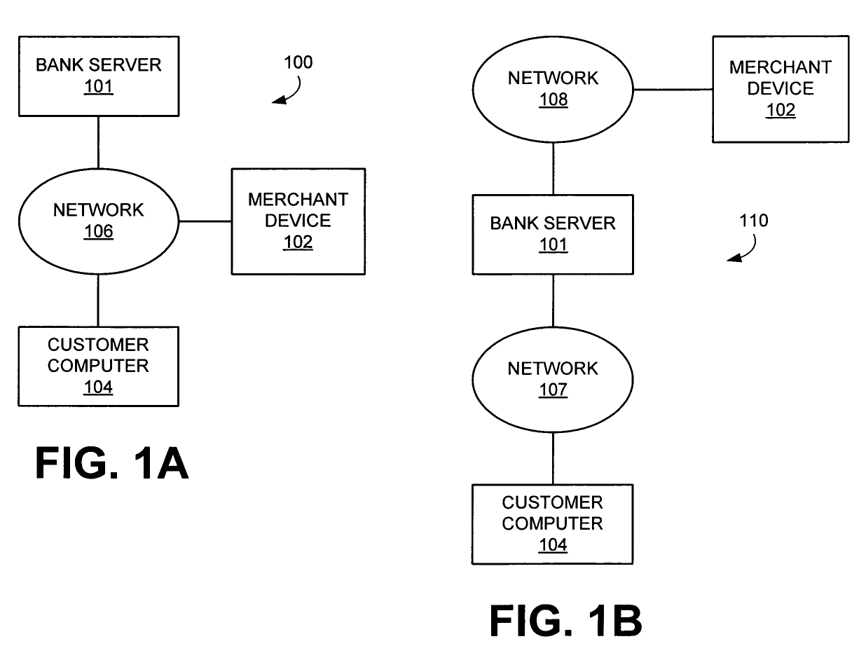

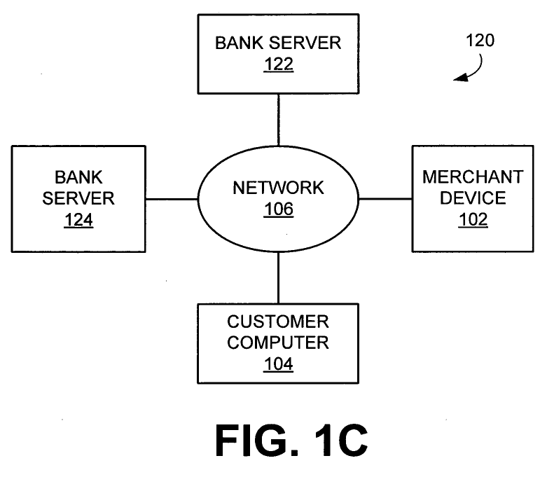

FIG. 1A is a block diagram illustrating an embodiment of a transaction system 100.

The transaction system 100 includes a bank server 101 that is coupled to a merchant device 102 and to a customer computer 104 via a network 106 (e.g., the Internet). It is also noted that more than one network can be used to couple the bank server 101 to the customer computer 104 and merchant device 102, as shown, for example, in FIG. 1B. The customer computer 104 can be, for example, a desktop computer, a notebook computer or a PDA (personal digital assistant).

The bank server 101 is used to manage bank customer accounts. The bank server 101 (or other server in communication with the bank server) can store relevant customer account data, including, for example, account identifiers, debit card numbers and merchant code restrictions. If the network 106 is the Internet, then the customer computer 104 can include an Internet browser that enables a bank customer to log onto the bank server 101. When a customer presents his or her debit card to a merchant to complete a transaction, the merchant transmits an authorization request to the bank server 101 via a merchant device 102. In an alternative embodiment, authorization requests may be handled via one server and account management may be handled via another server, as shown in FIG. 1C.

FIG. 1B is a block diagram illustrating an embodiment of a transaction system 110.

The transaction system 100 includes a bank server 101 that is coupled to a customer computer 104 via a network 107 (e.g., the Internet), and to a merchant device 102 via another network 108. The bank server 101, merchant device 102 and customer computer 104 can function in a similar manner as described in FIG. 1A except that respective networks are used by the bank server 101 to communicate with the merchant device 102 and the customer computer 104.

FIG. 1C is a block diagram illustrating an embodiment of a transaction system 120.

The transaction system 120 includes a bank server 122, a bank server 124, a merchant device 102 and a customer computer 104 that are coupled via a network 106 (e.g., the Internet). The bank server 124 is used to manage bank customer accounts. The bank server 122 is used to process transaction authorization requests. A bank customer uses the customer computer 104 to transmit a merchant code restriction to the bank server 124. The merchant device 102 communicates with the bank server 122 to request a transaction authorization for a transaction corresponding to a debit card used by the bank customer. In an alternative embodiment, the bank server 124 communicates with the customer computer 104 via a first network whereas the bank server 122 communicates with the merchant device via a second network (not shown in FIG. 1C) which may or may not be coupled to the first network.

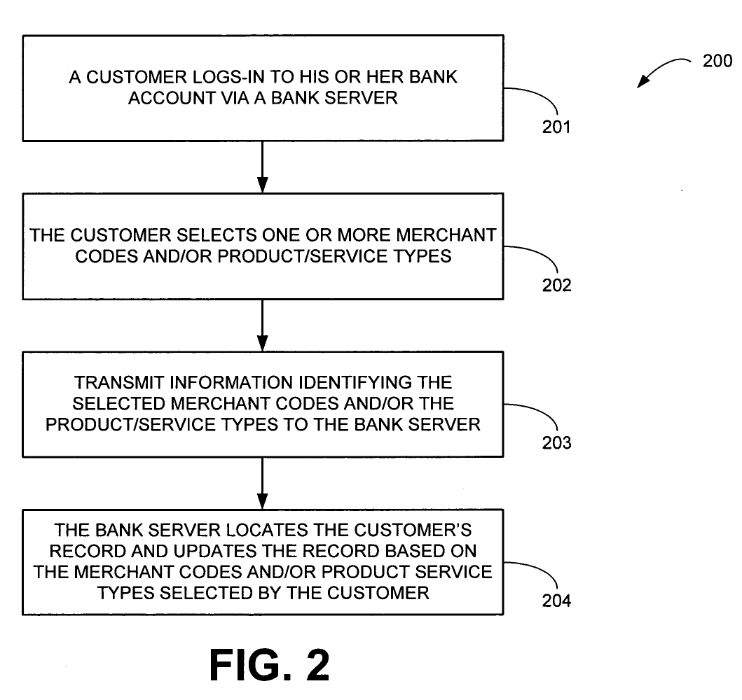

FIG. 2 is a flowchart depicting an embodiment of a method 200 for setting merchant code restrictions for a debit card account. As indicated in step 201, a customer logs-in to his or her account via a bank server (e.g., via the Internet or other computer network). The customer is required to provide correct authentication information such as a customer ID and/or password in order to successfully log into the bank server.

After the customer logs into his or her account, the customer selects one or more merchant codes and/or product/service types, as indicated in step 202. The customer can be presented with a list of merchant codes and/or product/service type options by the bank server. In one embodiment, the customer selects merchant codes and/or product/service types to be approved. In another embodiment, the customer selects merchant codes and/or product/service types to be declined. The selections can be made via an input device such as, for example, a keyboard or mouse.

After the customer selects the merchant codes and/or product/service types, information identifying the selected merchant codes and/or product/service types is transmitted to the bank server, as indicated in step 203. Responsive to receiving the transmitted information, the bank server locates the customer's record and updates the record to reflect the selected merchant code and/or product/service types, as indicated in step 204.

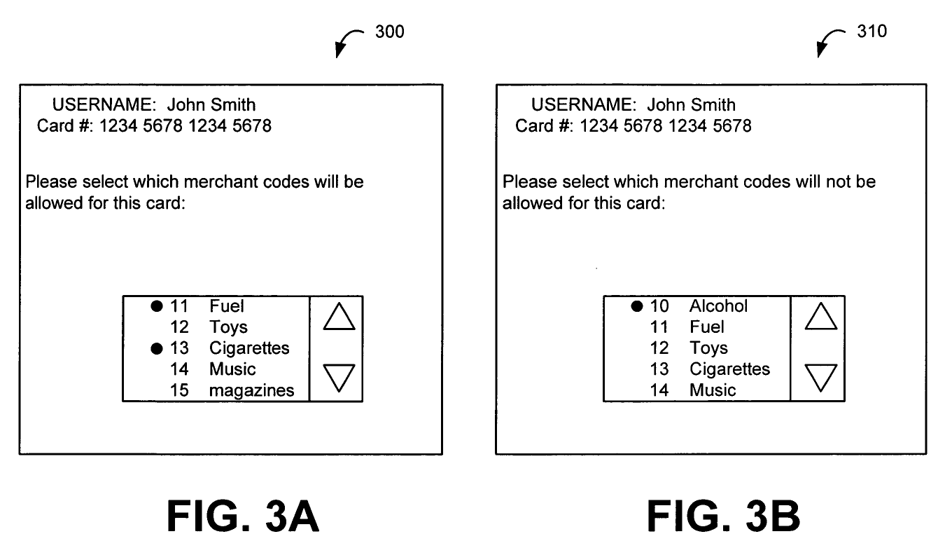

FIG. 3A is a diagram depicting an embodiment of a graphical user interface (GUI) 300 used to select authorized merchant codes. In this example, the GUI 300 indicates that the customer has selected merchant codes corresponding to only fuel and cigarettes. Thus, when the respective card is subsequently presented for a transaction, it will be declined unless the merchant code for the products being purchased corresponds to fuel or cigarettes. For example, a customer may be taking a long drive and wishes to prevent himself from using his card for goods/services other than fuel and cigarettes. In this way, the customer (e.g., the person whose name is identified on the debit card) can set his or her own transaction restrictions.

In an alternative embodiment, a customer selects purchase categories (i.e., products and/or services) for which authorization requests are to be approved, without directly selecting merchant codes. Each purchase category that is selected can correspond to one or more merchant codes. Thereafter, authorization requests having merchant codes that do not correspond to the selected purchase categories are declined.

FIG. 3B is a diagram depicting an embodiment of a GUI 310 used to select unauthorized merchant codes. In this example, the GUI 310 indicates that the customer has selected a merchant code corresponding to alcohol. Thus, when the respective card is subsequently presented for a transaction, it will be declined if the merchant code for the products being purchased corresponds to alcohol.

In an alternative embodiment, a customer selects purchase categories (i.e., products and/or services) for which authorization requests are to be declined, without directly selecting merchant codes. Each purchase category that is selected can correspond to one or more merchant codes. Thereafter, authorization requests having merchant codes that correspond to the selected purchase categories are declined.

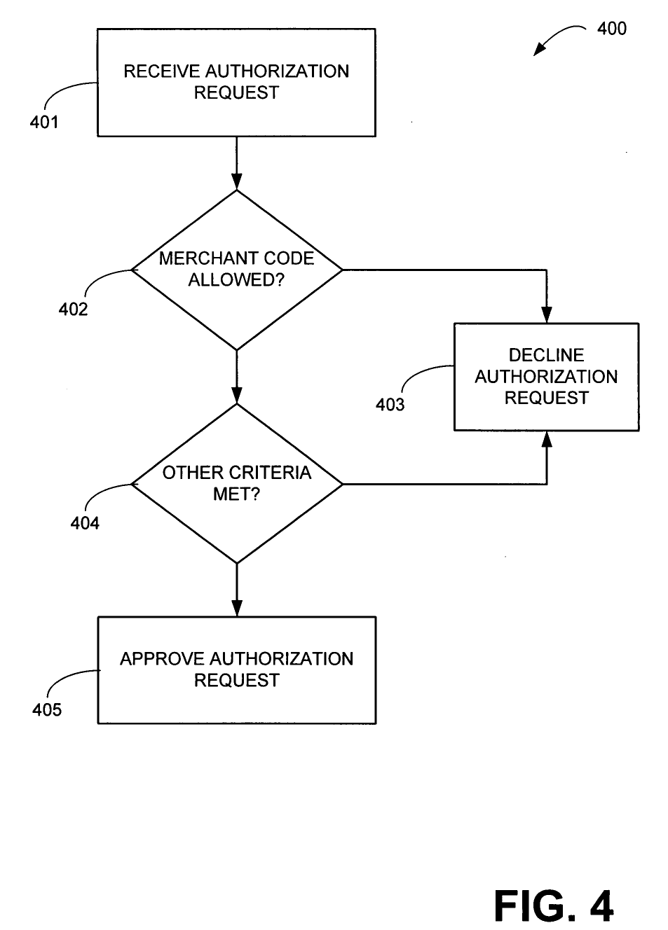

FIG. 4 is a flowchart depicting an embodiment of a method 400 for processing an authorization request with merchant code limitations. As indicated in step 401, an authorization request is received (e.g., by a bank server). The request can be transmitted by a merchant when a transaction is being processed. The authorization request includes, for example, a debit card number, a purchase amount, and a merchant code for the goods and/or services that are the subject of the transaction.

After the authorization request is received, a determination is made as to whether the merchant code corresponding to the transaction is allowed for the debit card, as indicated in step 402. This determination can be performed by comparing the received merchant code with a list of merchant codes in a respective database record associated with the card. In one embodiment, the database record includes a list of unauthorized merchant codes. In another embodiment, the database record includes a list of authorized merchant codes. If the merchant code is not allowed, then the authorization request is declined, as indicated in step 403.

If the merchant code is allowed, then a determination is made as to whether other authorization criteria are met, as indicated in step 404. For example, a determination is made as to whether the account associated with the debit card still is valid and has sufficient funds. If the other authorization criteria are not met, then the authorization request is declined as indicated in step 403.

If the other authorization criteria are met, then an authorization request is approved, as indicated in step 405. The authorization request can be approved by sending an approval message to the merchant. Other steps can also be carried out after the authorization request is approved, such as, for example, deducting the purchase amount from the customer's account balance.

Some of the steps described above can be optional or performed in a different order than that shown, such as, for example, simultaneously or in reverse order. Each step can be implemented via software, hardware, and/or firmware, depending on a desired implementation. Furthermore, some alternative embodiments may include similar steps to those described above.

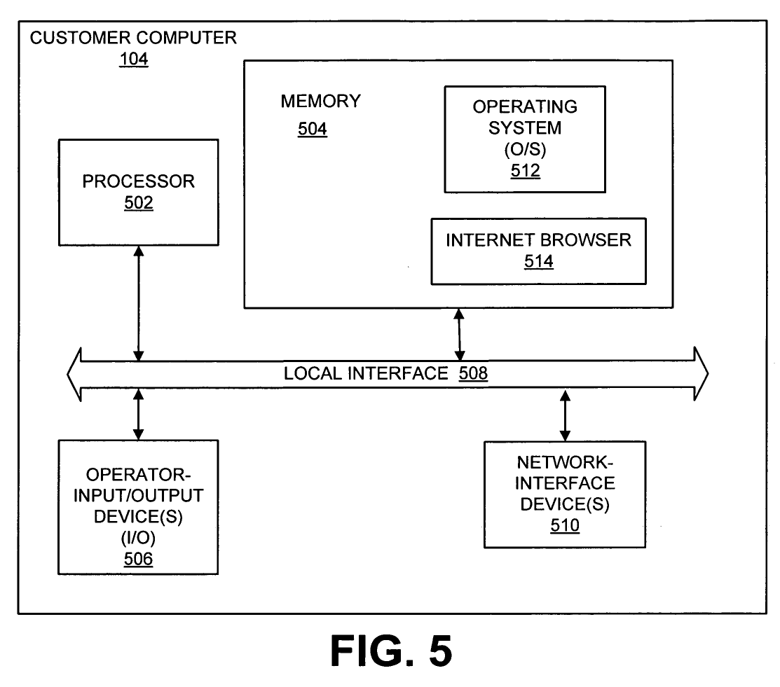

FIG. 5 is a block diagram illustrating an embodiment of a customer computer 104 that is used by a bank customer to remotely set or change debit card settings. The customer computer 104 includes a processor 502, memory 504, network interface device(s) 510, and one or more user input and/or output (I/O) device(s) 506 (or peripherals) that are communicatively coupled via a local interface 508.

The local interface 508 can be, for example but is not limited to, one or more buses or other wired or wireless connections, as is known in the art. The local interface 508 might have additional elements, which are omitted for simplicity, such as controllers, buffers (caches), drivers, repeaters, and receivers, to enable communications. Further, the local interface 508 might include address, control, and/or data connections to enable appropriate communications among the aforementioned components.

Processor 502 is a hardware device for executing software, particularly that stored in memory 504. The processor 502 can be any custom made or commercially available processor, a central processing unit (CPU), an auxiliary processor among several processors associated with the underwriter system, a semiconductor based microprocessor (in the form of a microchip or chip set), or generally any device for executing software instructions.

The memory 504 can include any one or combination of volatile memory elements (e.g., RAM, such as DRAM, SRAM, SDRAM, etc.) and nonvolatile memory elements (e.g., ROM, flash memory, etc.). Moreover, the memory 504 might incorporate electronic, magnetic, optical, and/or other types of storage media. Note that the memory 504 can have a distributed architecture, where various components are situated remote from one another, but can be accessed by the processor 502.

The user I/O device(s) 506 includes input devices such as, for example but not limited to, a keyboard, mouse, scanner, microphone, a touch sensitive display etc. Furthermore, the user I/O device(s) 506 also include output devices such as, for example but not limited to, a printer, display, etc. The network interface device(s) 510 include, for example, a modem, a radio frequency (RF) or other transceiver, a telephonic interface, an Ethernet interface, a bridge, and/or a router.

Software stored in memory 504 may include one or more separate programs, each one of which comprises an ordered listing of executable instructions for implementing logical functions. In the example of FIG. 5, the software in the memory 504 includes operating system 512 and an Internet browser 514. Among other things, the operating system 512 essentially controls the execution of the Internet browser 514 and provides scheduling, input-output control, file and data management, memory management, and communication control and related services. The Internet browser 514 is used by a customer to communicate with a bank server (e.g., bank server 101) via the network 106 (FIG. 1A).

The Internet browser 514 is a source program, executable program (object code), script, or any other entity comprising a set of instructions to be performed. When implemented as a source program, the Internet browser 514 is translated via a compiler, assembler, interpreter, or the like, which may or may not be included within the memory 504, so as to operate properly in connection with the O/S 512. Furthermore, the Internet browser 514 can be written in one or more object oriented programming languages, which have classes of data and methods, or procedure programming languages, which have routines, subroutines, and/or functions. In an embodiment, other communication software can be used, depending on a desired implementation.

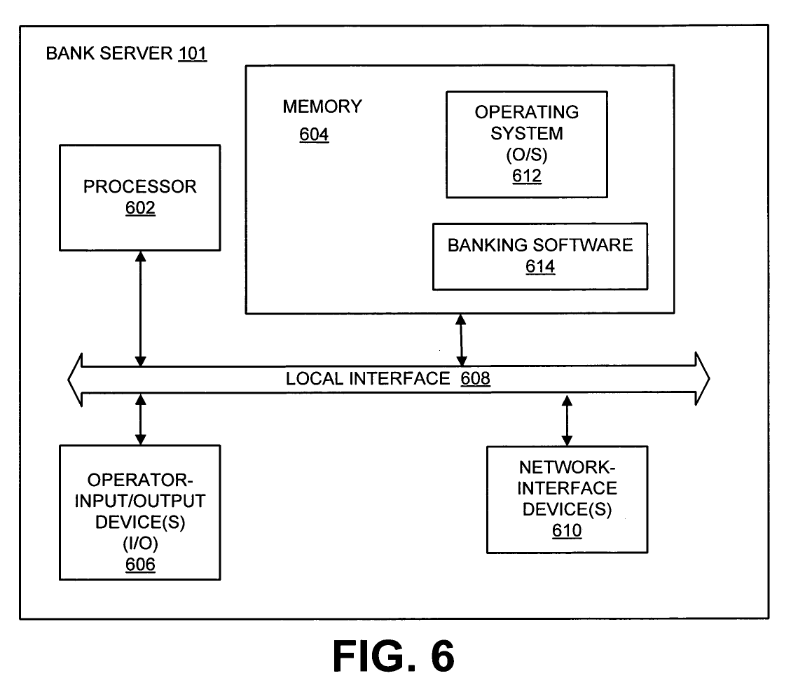

FIG. 6 is a block diagram illustrating an embodiment of a bank server 101 that can be used to modify debit card settings responsive to user input and/or to implement transaction authorizations pursuant to the debit card settings. The bank server 101 includes a processor 602, memory 604, network interface device(s) 610, and one or more user input and/or output (I/O) device(s) 606 (or peripherals) that are communicatively coupled via a local interface 608.

The local interface 608 can be, for example but is not limited to, one or more buses or other wired or wireless connections, as is known in the art. The local interface 608 might have additional elements, which are omitted for simplicity, such as controllers, buffers (caches), drivers, repeaters, and receivers, to enable communications. Further, the local interface 608 might include address, control, and/or data connections to enable appropriate communications among the aforementioned components.

Processor 602 is a hardware device for executing software, particularly that stored in memory 604. The processor 602 can be any custom made or commercially available processor, a central processing unit (CPU), an auxiliary processor among several processors associated with the underwriter system, a semiconductor based microprocessor (in the form of a microchip or chip set), or generally any device for executing software instructions.

The memory 604 can include any one or combination of volatile memory elements (e.g., RAM, such as DRAM, SRAM, SDRAM, etc.) and nonvolatile memory elements (e.g., ROM, flash memory, etc.). Moreover, the memory 604 might incorporate electronic, magnetic, optical, and/or other types of storage media. Note that the memory 604 can have a distributed architecture, where various components are situated remote from one another, but can be accessed by the processor 602.

The user I/O device(s) 606 includes input devices such as, for example but not limited to, a keyboard, mouse, scanner, microphone, a touch sensitive display etc. Furthermore, the user I/O device(s) 606 also include output devices such as, for example but not limited to, a printer, display, etc. The network interface device(s) 610 include, for example, a modem, a radio frequency (RF) or other transceiver, a telephonic interface, an Ethernet interface, a bridge, and/or a router.

Software stored in memory 604 may include one or more separate programs, each one of which comprises an ordered listing of executable instructions for implementing logical functions. In the example of FIG. 6, the software in the memory 604 includes operating system 612 and banking software 614. Among other things, the operating system 612 essentially controls the execution of the banking software 614 and provides scheduling, input-output control, file and data management, memory management, and communication control and related services.

The banking software 614 is used by the bank server 101 to communicate with a customer computer 104 via the network 106 (FIG. 1A) and to implement changes to debit card settings responsive to customer input provided via the customer computer 104. An example of the debit card settings that can be changed via the banking software 614 is a merchant code restriction that restricts the types of products or services that can be purchased by the debit card.

The banking software 614 is a source program, executable program (object code), script, or any other entity comprising a set of instructions to be performed. When implemented as a source program, the banking software 614 is translated via a compiler, assembler, interpreter, or the like, which may or may not be included within the memory 604, so as to operate properly in connection with the O/S 612. Furthermore, the banking software 614 can be written in one or more object oriented programming languages, which have classes of data and methods, or procedure programming languages, which have routines, subroutines, and/or functions.

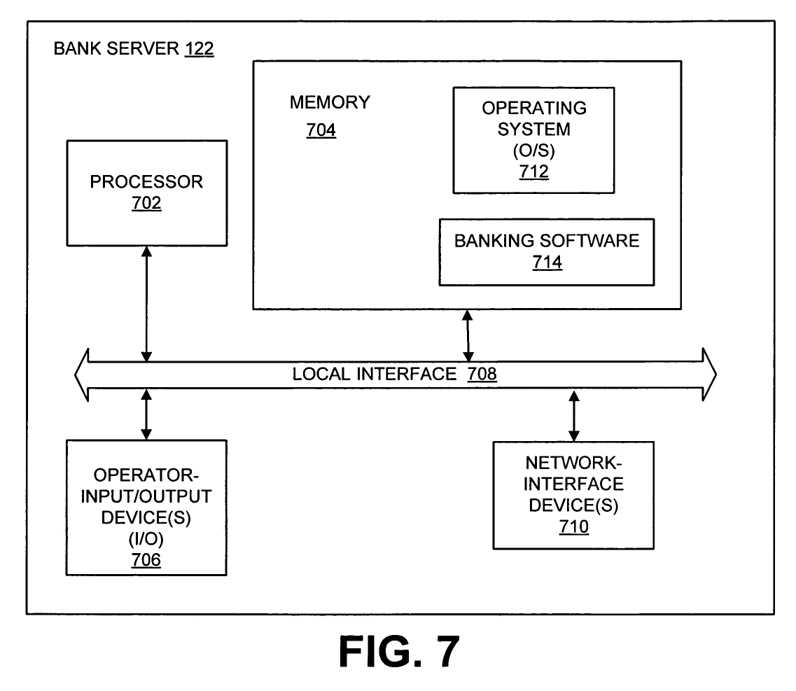

FIG. 7 is a block diagram illustrating an embodiment of a bank server 122 that can be used to process an authorization request corresponding to a debit card account. The bank server 122 approves or declines a debit card authorization request responsive to a product type and/or merchant code restriction requested by a corresponding bank customer. The bank server 122 includes a processor 702, memory 704, network interface device(s) 710, and one or more user input and/or output (I/O) device(s) 706 (or peripherals) that are communicatively coupled via a local interface 708.

The local interface 708 can be, for example but is not limited to, one or more buses or other wired or wireless connections, as is known in the art. The local interface 708 might have additional elements, which are omitted for simplicity, such as controllers, buffers (caches), drivers, repeaters, and receivers, to enable communications. Further, the local interface 708 might include address, control, and/or data connections to enable appropriate communications among the aforementioned components.

Processor 702 is a hardware device for executing software, particularly that stored in memory 704. The processor 702 can be any custom made or commercially available processor, a central processing unit (CPU), an auxiliary processor among several processors associated with the underwriter system, a semiconductor based microprocessor (in the form of a microchip or chip set), or generally any device for executing software instructions.

The memory 704 can include any one or combination of volatile memory elements (e.g., RAM, such as DRAM, SRAM, SDRAM, etc.) and nonvolatile memory elements (e.g., ROM, flash memory, etc.). Moreover, the memory 704 might incorporate electronic, magnetic, optical, and/or other types of storage media. Note that the memory 704 can have a distributed architecture, where various components are situated remote from one another, but can be accessed by the processor 702.

The user I/O device(s) 706 includes input devices such as, for example but not limited to, a keyboard, mouse, scanner, microphone, a touch sensitive display etc. Furthermore, the user I/O device(s) 706 also include output devices such as, for example but not limited to, a printer, display, etc. The network interface device(s) 710 include, for example, a modem, a radio frequency (RF) or other transceiver, a telephonic interface, an Ethernet interface, a bridge, and/or a router.

Software stored in memory 704 may include one or more separate programs, each one of which comprises an ordered listing of executable instructions for implementing logical functions. In the example of FIG. 7, the software in the memory 704 includes operating system 712 and banking software 714. Among other things, the operating system 712 essentially controls the execution of the banking software 714 and provides scheduling, input-output control, file and data management, memory management, and communication control and related services.

The banking software 714 is used by the bank server 122 to communicate with a merchant device 102 (FIG. 1 C) and to either approve or decline a debit card authorization request responsive to a purchase category and/or a merchant code corresponding to the transaction. For example, if a bank customer had identified alcohol as being an unapproved purchase category for the bank customer's debit card account, then the banking software 714 will cause an authorization request for an attempted alcohol purchase via the debit card to be declined. As another example, if a bank customer had identified alcohol merchants as being unapproved merchants for the bank customer's debit card, then the banking software 714 will cause an authorization request for an attempted purchase from an alcohol vendor via the debit card to be declined.

The banking software 714 is a source program, executable program (object code), script, or any other entity comprising a set of instructions to be performed. When implemented as a source program, the banking software 714 is translated via a compiler, assembler, interpreter, or the like, which may or may not be included within the memory 704, so as to operate properly in connection with the O/S 712. Furthermore, the banking software 714 can be written in one or more object oriented programming languages, which have classes of data and methods, or procedure programming languages, which have routines, subroutines, and/or functions.

While various embodiments of the systems and methods for implementing debit card account restrictions have been described, it will be apparent to those of ordinary skill in the art that many more embodiments and implementations are possible that are within the scope of this disclosure. Accordingly, the present systems and methods are not to be restricted except in light of the following claims and their equivalents.

What is claimed is:

1. A method comprising:
receiving from a remotely located computer information identifying at least one purchase category, wherein the information is transmitted by the computer responsive to user input provided to the computer by a bank customer having a debit card account with a bank;
after receiving the information identifying the at least one purchase category, receiving an authorization request for a transaction corresponding to the debit card account; and
causing the authorization request to be declined responsive to the at least one purchase category.

2. The method of claim 1, further comprising:
receiving a merchant code corresponding to the transaction.

3. The method of claim 2, wherein authorization requests corresponding to the at least one purchase category are to be approved, and wherein the authorization request is declined if the merchant code does not correspond to one of the at least one purchase category.

4. The method of claim 2, wherein authorization requests corresponding to the at least one purchase category are to be decline, and wherein the authorization request is declined if the merchant code corresponds to one of the at least one purchase category.

5. The method of claim 1, wherein each of the at least one purchase category corresponds to at least one merchant code.

6. The method of claim 1, further comprising:
prior to receiving the information identifying at least one purchase category, transmitting to the remotely located computer information identifying a list of purchase categories.

7. A server configured to implement the method of claim 1.

8. Software configured to implement the method of claim 1.

9. A computer readable medium having stored thereon the software of claim 4.

10. A method comprising:
receiving from a remotely located computer information identifying at least one merchant category, wherein the information is transmitted by the computer responsive to user input provided to the computer by a bank customer having a debit card account with a bank;
after receiving the information identifying the at least one merchant category, receiving an authorization request for a transaction corresponding to the debit card account; and
causing the authorization request to be declined responsive to the at least one merchant category.

11. The method of claim 10, further comprising:
receiving a merchant code corresponding to the transaction.

12. The method of claim 11, wherein authorization requests corresponding to the at least one merchant category are to be approved, and wherein the authorization request is declined if the merchant code does not correspond to one of the at least one merchant category.

13. The method of claim 11, wherein authorization requests corresponding to the at least one merchant category are to be declined, and wherein the authorization request is declined if the merchant code corresponds to one of the at least one merchant category.

14. The method of claim 10, wherein each of the at least one merchant category corresponds to a merchant code.

15. A server configured to implement the method of claim 10.

16. Software configured to implement the method of claim 10.

17. A computer readable medium having stored thereon the software of claim 16.

18. A system comprising:
a first server configured to receive from a remotely located computer information identifying at least one purchase category, wherein the information is transmitted by the computer responsive to user input provided to the computer by a bank customer having a debit card account with a bank; and
a second server configured to:
receive an authorization request for a transaction corresponding to the debit card account; and
cause the authorization request to be declined responsive to the at least one purchase category.

19. The system of claim 18, wherein authorization requests corresponding to the at least one purchase category are to be approved, and wherein the authorization request is declined if a merchant code for the transaction does not correspond to one of the at least one purchase category.

20. The system of claim 18, wherein authorization requests corresponding to the at least one purchase category are to be decline, and wherein the authorization request is declined if a merchant code for the transaction corresponds to one of the at least one purchase category.
